(19) United States
(12) Patent Application Publication
(10) Pub. No.: US 2022/0271639 A1
(43) Pub. Date: Aug. 25, 2022

(54) CLAW POLE ROTOR FOR AN ELECTRICAL MACHINE AND ROTOR ARRANGEMENT FOR AN ELECTRICAL MACHINE

(71) Applicant: FEAAM GmbH, Neubiberg (DE)

(72) Inventor: Gurakuq DAJAKU, Neubiberg (DE)

(21) Appl. No.: 17/677,984

(22) Filed: Feb. 22, 2022

(30) Foreign Application Priority Data
Feb. 23, 2021 (DE) 10 2021 104 275.5

(51) Int. Cl. H02K 21/04; H02K 1/2713

(52) U.S. Cl. CPC H02K 21/044; H02K 1/2713

(57) ABSTRACT

A claw pole rotor (10) for an electrical machine (11) is specified, the claw pole rotor (10) comprising a rotor yoke (12), and at least two first claw pole fingers (13) and at least two second claw pole fingers (14), wherein the first and second claw pole fingers (13, 14) each are connected with the rotor yoke (12), the first claw pole fingers (13) extend from a first side (15) of the claw pole rotor (10) towards a second side (16) of the claw pole rotor (10), the second claw pole fingers (14) extend from the second side (16) towards the first side (15), one first magnet (17) is in each case arranged at the first side (15) between the first claw pole fingers (13), and one second magnet (18) is in each case arranged at the second side (16) between the second claw pole fingers (14). Moreover, a rotor arrangement (23) for an electrical machine (11) is specified.

The present application relates to a claw pole rotor for an electrical machine and a rotor arrangement for an electrical machine.

Typically, electrical machines comprise a stator and a rotor that is movable relative thereto. Electrical machines can work in a motoric or generative manner, wherein electrical energy is converted into kinetic energy or vice versa. During operation, a magnetic field of the rotor interacts with a magnetic field of the stator.

A claw pole rotor usually includes two components having claw pole fingers. The claw pole fingers constitute magnetic poles of the claw pole rotor. By means of an exciter coil in the claw pole rotor, the magnetic flux in the rotor may be increased, resulting in a higher torque of the electrical machine having the claw pole rotor. This means that the electrical machine can be operated more efficiently.

A task to be solved is to propose a claw pole rotor for an electrical machine, which can be operated efficiently. A further task to be solved is to propose a rotor arrangement for an electrical machine, which can be operated efficiently.

The tasks are solved by the subject matter of the independent claims. Advantageous configurations and further developments are indicated in the subclaims.

According to at least one embodiment of the claw pole rotor for an electrical machine, the claw pole rotor comprises a rotor yoke. The rotor yoke may comprise a rotor core. The rotor yoke is arranged at least in some places within the claw pole rotor. At least in some places, the rotor yoke has the shape of a cylinder. In addition, the rotor yoke may include a first annular component and a second annular component. The rotor yoke may include a ferromagnetic material, for example iron or steel. It is further possible for the rotor yoke to comprise soft magnetic composite powder materials.

The claw pole rotor further comprises at least two first claw pole fingers and at least two second claw pole fingers. From an external view onto the claw pole rotor, the claw pole fingers each may have approximately the shape of a parallelogram. In total, each of the claw pole fingers may have a curved shape. In this case, the curved shape of a claw pole finger respectively extends along the circumference of the claw pole rotor. Each of the claw pole fingers may extend farther along a longitudinal axis of the claw pole rotor than along the circumference of the claw pole rotor. The claw pole fingers may be arranged at an outside of the claw pole rotor. The claw pole fingers may comprise the same material as the rotor yoke. This means that the claw pole fingers may comprise a ferromagnetic material, for example iron or steel. It is further possible for the claw pole fingers to comprise soft magnetic composite powder materials. The first claw pole fingers each may have the same size and shape. The second claw pole fingers each may have the same size and shape. It is further possible for all of the claw pole fingers, i.e. the first and second claw pole fingers, to have the same size and shape in each case. The claw pole rotor may comprise the same number of first claw pole fingers as second claw pole fingers.

The first and second claw pole fingers each are connected with the rotor yoke. This may mean that the first and second claw pole fingers are attached to the rotor yoke. The claw pole fingers may be formed in one piece with the rotor yoke. Alternatively, the claw pole fingers each may be separate components connected with the rotor yoke. The first claw pole fingers may be connected with the first annular component of the rotor yoke. The second claw pole fingers may be connected with the second annular component of the rotor yoke.

The first claw pole fingers extend from a first side of the claw pole rotor towards a second side of the claw pole rotor. The second claw pole fingers extend from the second side towards the first side. The first side of the claw pole rotor is opposite the second side of the claw pole rotor. This means that along the longitudinal axis of the claw pole rotor, the first side is arranged at one end of the claw pole rotor, and the second side is arranged at the other end of the claw pole rotor. The first annular component of the rotor yoke may be arranged at the first side. The second annular component of the rotor yoke may be arranged at the second side. The first claw pole fingers may be connected with the rotor yoke at the first side. The second claw pole fingers may be connected with the rotor yoke at the second side. The first and second claw pole fingers may have a main extension direction, which runs in parallel to the longitudinal axis of the claw pole rotor.

The first claw pole fingers and the second claw pole fingers may be arranged alternatingly along the circumference of the claw pole rotor. This means that along the circumference of the claw pole rotor, each first claw pole finger is arranged between two second claw pole fingers. Likewise, each second claw pole finger is arranged along the circumference of the claw pole rotor between two first claw pole fingers. In this case, each first claw pole finger is arranged spaced from the respective adjacent second claw pole fingers. This means that a gap remains in each case between one first claw pole finger and one second claw pole finger.

The first claw pole fingers may have a shape tapering from the first to the second side. The second claw pole fingers may have a shape tapering from the second to the first side. In this case, the extension of the claw pole fingers respectively tapers along the circumference of the claw pole rotor. Moreover, or alternatively, the shape of the first claw pole fingers respectively may taper such that the first claw pole fingers at the first side of the claw pole rotor have a larger extension in a radial direction in a cross-section through the claw pole rotor than at a position, which is not arranged at the first side. Moreover, or alternatively, the shape of the second claw pole fingers respectively may taper such that the second claw pole fingers at the second side of the claw pole rotor have a larger extension in a radial direction in a cross-section through the claw pole rotor than at a position, which is not arranged at the second side.

At the first side, one first magnet is respectively arranged between the first claw pole fingers. This means that between two first claw pole fingers, one first magnet is in any case arranged at the first side. Thus, the claw pole rotor comprises as many first magnets as first claw pole fingers as a whole. The first magnets each are arranged along the circumference of the claw pole rotor between two first claw pole fingers. The first magnets may be arranged spaced from the first claw pole fingers. This may mean that a gap remains in each case between each first magnet and the adjacent first claw pole fingers. The first magnets each may be a permanent magnet. In a view onto the outside of the claw pole rotor, the first magnets each may have approximately the shape of a rectangle. The first magnets may have a curved shape along the circumference of the claw pole rotor. The first magnets may have the same extension along a radial direction in a cross-section through the claw pole rotor at the first side as the first claw pole fingers at the first side.

At the second side, one second magnet is respectively arranged between the second claw pole fingers. This means that one second magnet is in each case arranged at the second side between two second claw pole fingers. Thus, the claw pole rotor has the same number of second magnets as second claw pole fingers as a whole. The second magnets each are arranged along the circumference of the claw pole rotor between two second claw pole fingers. The second magnets may be arranged spaced from the second claw pole fingers. This may mean that a gap remains in each case between each second magnet and the adjacent second claw pole fingers. The second magnets each may be a permanent magnet. In a view onto the outside of the claw pole rotor, the second magnets each may have approximately the shape of a rectangle. The second magnets may have a curved shape along the circumference of the claw pole rotor. The second magnets may have the same extension along a radial direction in a cross-section through the claw pole rotor at the second side as the second claw pole fingers at the second side.

The first magnets each may have the same shape and size. The second magnets each may have the same shape and size. It is further possible for all of the magnets, i.e. the first and second magnets, to have the same shape and size in each case.

The attachment of the first magnets at the first side and of the second magnates at the second side results in increasing the magnetic flux within the air gap of the electrical machine in which the claw pole rotor is used, when the electrical machine is operated. Thus, each first magnet contributes to magnetizing each of the two adjacent second claw pole fingers, and each second magnet contributes to magnetizing each of the two adjacent first claw pole fingers. The magnetic poles of the claw pole rotor are formed by the claw pole fingers. An enhanced magnetic flux results in the torque of the electrical machine to be increased. Thus, the electrical machine can be operated more efficiently.

The first magnets and the second magnets are arranged at a position which is usually not utilized for enhancing the magnetic flux. Due to the fact that the first magnets are arranged in the free installation space between the first claw pole fingers, and the second magnets are arranged in the free installation space between the second claw pole fingers, the installation space of the claw pole rotor is utilized more efficiently. The first and second magnets contribute to enhancing the magnetic flux within the air gap. By attaching the first and second magnets, the installation space between the claw pole fingers is also utilized for enhancing the magnetic flux. Thus, the efficiency of the electrical machine, in which the claw pole rotor is used, can be increased without enlarging the claw pole rotor.

According to at least one embodiment of the claw pole rotor, the first and second magnets each are attached to the rotor yoke. The first magnets are attached to the rotor yoke at the first side of the claw pole rotor, and the second magnets are attached to the rotor yoke at the second side of the claw pole rotor. The first magnets may be attached to the first annular component of the rotor yoke. The second magnets may be attached to the second annular component of the rotor yoke. The first magnets and the second magnets each may be glued to the rotor yoke. The rotor yoke offers high stability so that the first and second magnets may be attached to the rotor yoke advantageously in a stable manner. This enables the first magnets to be arranged spaced from the first claw pole fingers, and the second magnets to be arranged spaced from the second claw pole fingers. Due to that, flux leakage is avoided in the rotor yoke.

According to at least one embodiment of the claw pole rotor, the magnetizing direction of the first magnets and the second magnets respectively runs in parallel to a radial direction in a cross-section through the claw pole rotor. In a cross-section through the claw pole rotor, the radial directions run from the center point of the claw pole rotor to the outside of the claw pole rotor. The magnetizing directions of the first magnets are different from one another. Thus, the magnetizing direction of each first magnet respectively runs in parallel to the radial direction in a cross-section through the claw pole rotor at the respective position of the first magnet. This means that the magnetizing direction of each first magnet in a cross-section through the claw pole rotor may either run from the outside towards the center point of the claw pole rotor or from the center point towards the outside.

The magnetizing direction of each second magnet runs in each case in parallel to the radial direction in a cross-section through the claw pole rotor at the respective position of the second magnet. This means that the magnetizing direction of each second magnet may run in a cross-section through the claw pole rotor either from the outside towards the center point of the claw pole rotor or from the center point towards the outside. By means of the first and second magnets, for which the magnetizing direction runs in each case in parallel to a radial direction in a cross-section through the claw pole rotor, the magnetic flux within the air gap may be enhanced. Thus, an electrical machine having the claw pole rotor may be operated more efficiently.

According to at least one embodiment of the claw pole rotor, the magnetizing direction of the first magnets runs in each case in parallel to a radial direction in a cross-section through the claw pole rotor towards the center point of the claw pole rotor, and the magnetizing direction of the second magnets runs in each case in parallel to a radial direction in a cross-section through the claw pole rotor away from the center point of the claw pole rotor. This means that the magnetizing directions of the first magnets are different from one another, and point all towards the center point of the claw pole rotor. The magnetizing directions of the second magnets are likewise different from one another, and point all away from the center point of the claw pole rotor. This means that the magnetizing directions of the second magnets point towards the outside of the claw pole rotor. In this manner, the magnetic flux within the air gap may be enhanced by means of the first and second magnets. Thus, an electrical machine having the claw pole rotor may be operated more efficiently.

According to at least one embodiment of the claw pole rotor, the magnetizing direction of the second magnets runs in each case in parallel to a radial direction in a cross-section through the claw pole rotor towards the center point of the claw pole rotor, and the magnetizing direction of the first magnets runs in each case in parallel to a radial direction in a cross-section through the claw pole rotor away from the center point of the claw pole rotor. This means that the magnetizing directions of the second magnets are different from one another and point all towards the center point of the claw pole rotor. The magnetizing directions of the first magnets are likewise different from one another and point all away from the center point of the claw pole rotor. This means that the magnetizing directions of the first magnets point towards the outside of the claw pole rotor. In this manner, the magnetic flux within the air gap may be enhanced by means of the first and second magnets. Thus, an electrical machine having the claw pole rotor may be operated more efficiently.

According to at least one embodiment of the claw pole rotor, an exciter coil is arranged between the rotor yoke and the first and second claw pole fingers in the claw pole rotor. In a cross-section through the claw pole rotor, the exciter coil is arranged between the first and second claw pole fingers, on the one hand, and the rotor yoke, on the other hand. The exciter coil is configured to be supplied with direct current. The exciter coil may have the shape of a hollow cylinder. The exciter coil is arranged spaced from the first and second claw pole fingers. This means that a gap remains between the exciter coil and the first and second claw pole fingers. Due to the use of the exciter coil, the magnetic flux within the air gap may be further enhanced when the electrical machine is operated.

According to at least one embodiment of the claw pole rotor, the first and second claw pole fingers each have a shorter extension along a longitudinal axis of the claw pole rotor than the entire claw pole rotor. Thus, the first and second claw pole fingers each do not extend over the entire length of the claw pole rotor. This means that the first claw pole fingers do not extend completely from the first side to the second side. The second claw pole fingers do not extend completely from the second side to the first side. In this structure of the claw pole rotor, a space remains for the first and second magnets respectively between the first claw pole fingers and respectively between the second claw pole fingers. Thus, the first and second magnets each may be attached advantageously between the claw pole fingers to the rotor yoke.

According to at least one embodiment of the claw pole rotor, the first and second claw pole fingers each have along a longitudinal axis of the claw pole rotor at most the same extension as the entire claw pole rotor. This means that the first and second claw pole fingers may have the same length as the claw pole rotor. In this case, the first and second magnets each may have a recess for receiving a part of a claw pole finger. Alternatively, the first and second claw pole fingers are shorter along the longitudinal axis of the claw pole rotor than the claw pole rotor. In each case, the first and second claw pole fingers are arranged such that an installation space remains for the first and second magnets. Thus, the first and second magnets may advantageously contribute to enhance the magnetic flux within the air gap when the electrical machine is operated.

According to at least one embodiment of the claw pole rotor, the first and second magnets each have along a longitudinal axis of the claw pole rotor a shorter extension than the first and second claw pole fingers. The first magnets each may be arranged in a remaining installation space at the first side of the claw pole rotor, and the second magnets each may be arranged in a remaining installation space at the second side of the claw pole rotor. Thus, the installation space of the claw pole rotor is utilized efficiently.

According to at least one embodiment of the claw pole rotor, each first magnet is in direct contact with one of the second claw pole fingers, and each second magnet is in direct contact with one of the first claw pole fingers. For each first claw pole finger, there is arranged one second magnet at its side pointing towards the second side of the claw pole rotor. In this case, the second magnets each may be flush with the first claw pole fingers. Likewise, one first magnet is arranged for each second claw pole finger at its side pointing towards the first side of the claw pole rotor. In this case, the first magnets each may be flush with the second claw pole fingers.

By means of a surface extending perpendicular to a cross-section through the claw pole rotor, the first magnets each may be in direct contact with one of the second claw pole fingers. At the position where a first magnet is in direct contact with one of the second claw pole fingers, the respective first magnet and the respective second claw pole finger have the same extension along the circumference of the claw pole rotor. The sum of the length of one first magnet and the length of one second magnet along the longitudinal axis of the claw pole rotor may correspond to the entire length of the claw pole rotor. By means of a surface extending perpendicular to a cross-section through the claw pole rotor, the second magnets each may be in direct contact with one of the first claw pole fingers. At the position where a second magnet is in direct contact with one of the first claw pole fingers, the respective second magnet and the respective first claw pole finger have the same extension along the circumference of the claw pole rotor. The sum of the length of one second magnet and the length of one first claw pole finger along the longitudinal axis of the claw pole rotor may correspond to the entire length of the claw pole rotor.

Due to the fact that each first magnet is in direct contact with one of the second claw pole fingers, and each second magnet is in direct contact with one of the first claw pole fingers, the first and second magnets contribute in an efficient manner to enhance the magnetic flux within the air gap.

According to at least one embodiment of the claw pole rotor, the first and second magnets each have a recess in which a part of one of the claw pole fingers is arranged. This means that the first magnets each have a recess in which a part of one of the second claw pole fingers is arranged. The second magnets each have a recess in which a part of one of the first claw pole fingers is arranged. The recesses each may be adapted to the shape of the first and second claw pole fingers. In this embodiment, the first and second claw pole fingers may have the same extension along the longitudinal axis of the claw pole rotor as the claw pole rotor. Furthermore, it is possible for the sum of the length of one first magnet and the length of one second claw pole finger to be larger than the length of the claw pole rotor along its longitudinal axis. Likewise, the sum of the length of one second magnet and the length of one first claw pole finger may be larger than the length of the claw pole rotor along its longitudinal axis. For this purpose, one first magnet and one second claw pole finger each run coaxially in the area of the recess of the first magnet. Likewise, one second magnet and one first claw pole finger each run coaxially in the area of the recess of the second magnet. By means of this arrangement, the installation space of the claw pole rotor may be utilized efficiently. Moreover, the stability of the claw pole rotor is enhanced by this arrangement. Thus, the stability of the claw pole rotor is increased as a whole by arranging in each case a part of the claw pole fingers in a respective recess.

According to at least one embodiment of the claw pole rotor, the sum of the number of first magnets and the number of second magnets is equal to the number of the magnetic poles of the claw pole rotor. The claw pole rotor can comprise the same number of first magnets as second magnets. By means of this arrangement of the first and second magnets, the magnetic flux within the air gap is advantageously enhanced when the electrical machine is operated.

Furthermore, a rotor arrangement for an electrical machine is proposed. According to at least one embodiment of the rotor arrangement, the rotor arrangement comprises at least two of the claw pole rotors described here. Thus, all of the features of the described claw pole rotor are also disclosed for the rotor arrangement and vice versa. The two claw pole rotors may be connected with one another in a torque-proof manner. The two claw pole rotors may be in direct contact with one another. One of the claw pole rotors is arranged either at the first or the second side of the other claw pole rotor. The at least two claw pole rotors may have the same structure. By means of this rotor arrangement, the magnetic flux within the air gap may be further enhanced advantageously. Moreover, the entire length of the rotor arrangement may be increased.

According to at least one embodiment of the rotor arrangement, at least two of the claw pole rotors of the rotor arrangement have a structure different from one another. This means that the first of the two claw pole rotors has another structure than the second of the claw pole rotors. This means that the advantages of different embodiments of the claw pole rotor may be combined.

In the following, the claw pole rotor described here and the rotor arrangement will be explained in more detail in conjunction with exemplary embodiments and the associated Figures.

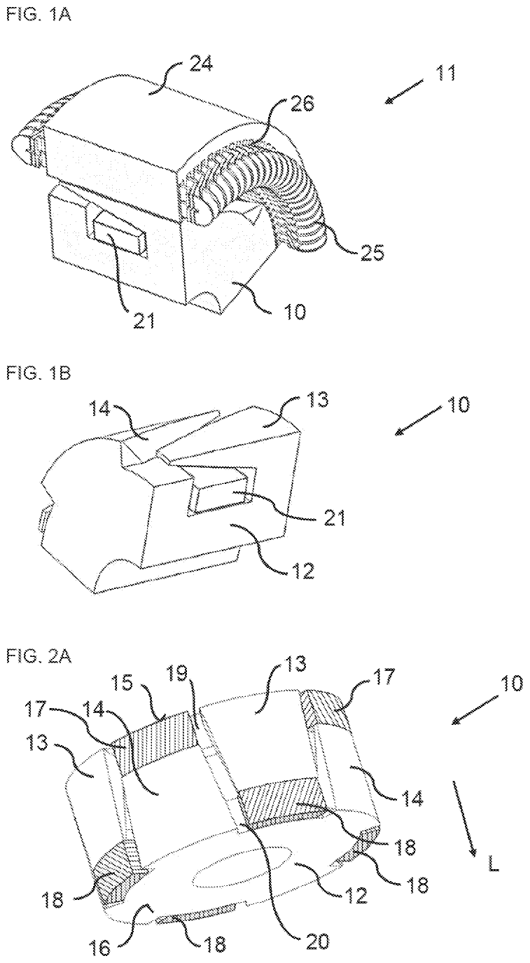

In FIGS. 1A and 1B, a schematic cross-section through a part of an example of an electrical machine is shown.

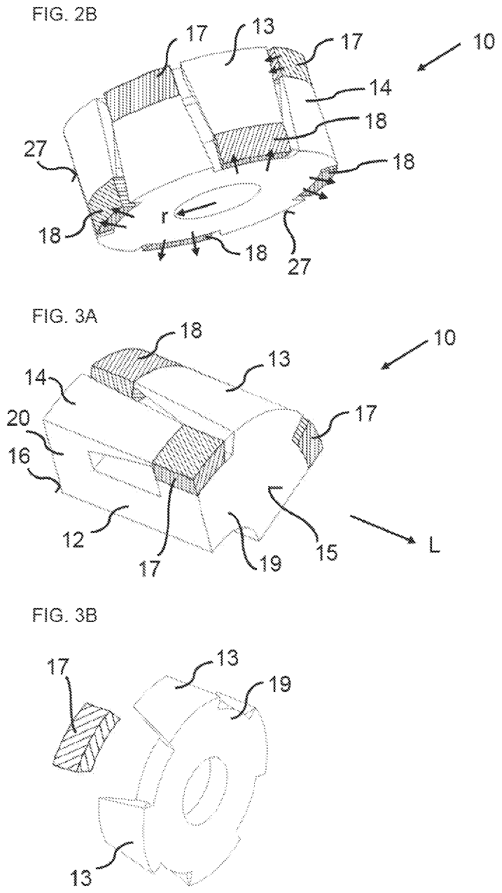

In FIGS. 2A and 2B, an exemplary embodiment of the claw pole rotor is shown.

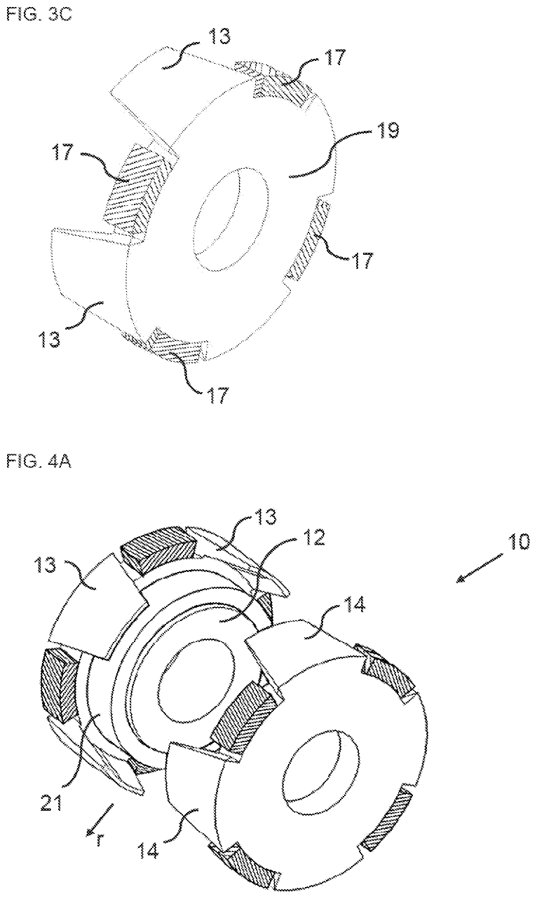

On the basis of FIGS. 3A, 3B and 3C, parts of an exemplary embodiment of the claw pole rotor are described.

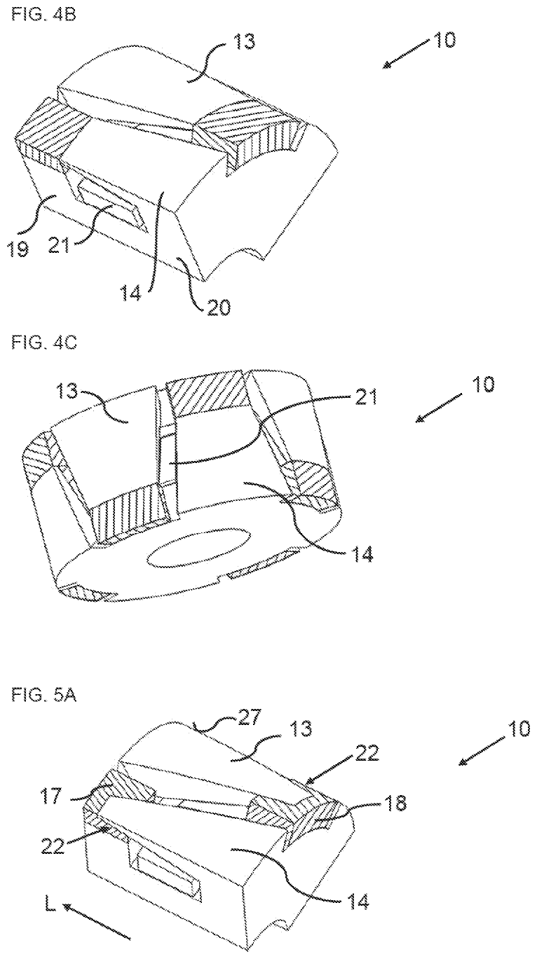

On the basis of FIGS. 4A, 4B and 4C, a further exemplary embodiment of the claw pole rotor is described.

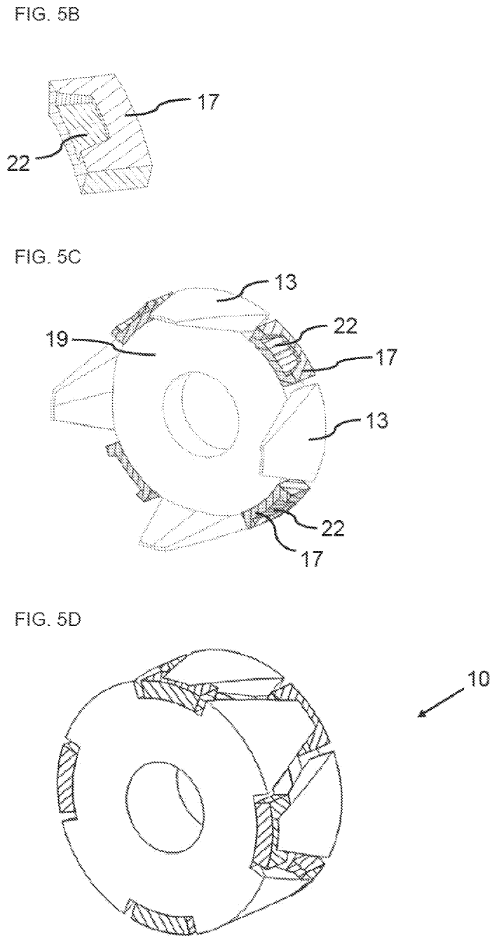

On the basis of FIG. 5A, 5B, 5C and 5D, a further exemplary embodiment of the claw pole rotor is described.

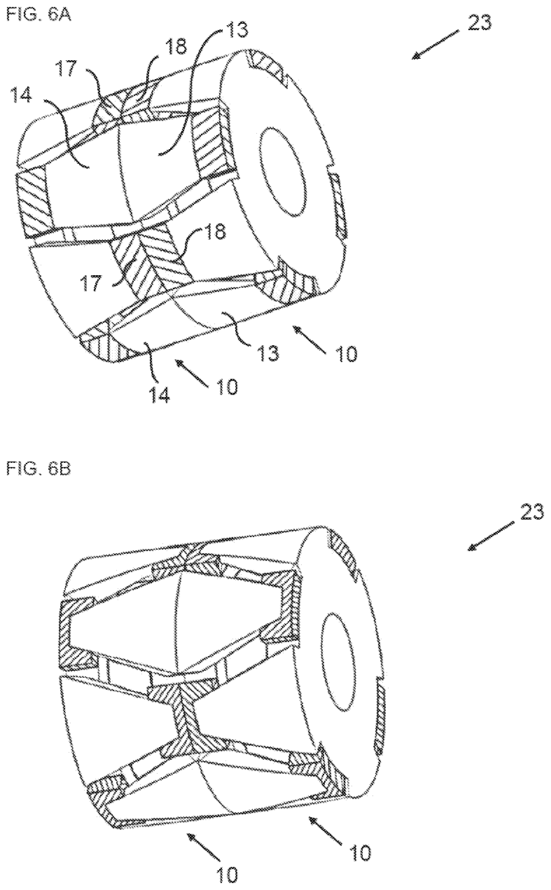

In FIG. 6A, an exemplary embodiment of the rotor arrangement is shown.

In FIGS. 6B and 6C, further exemplary embodiments of the rotor arrangement are shown.

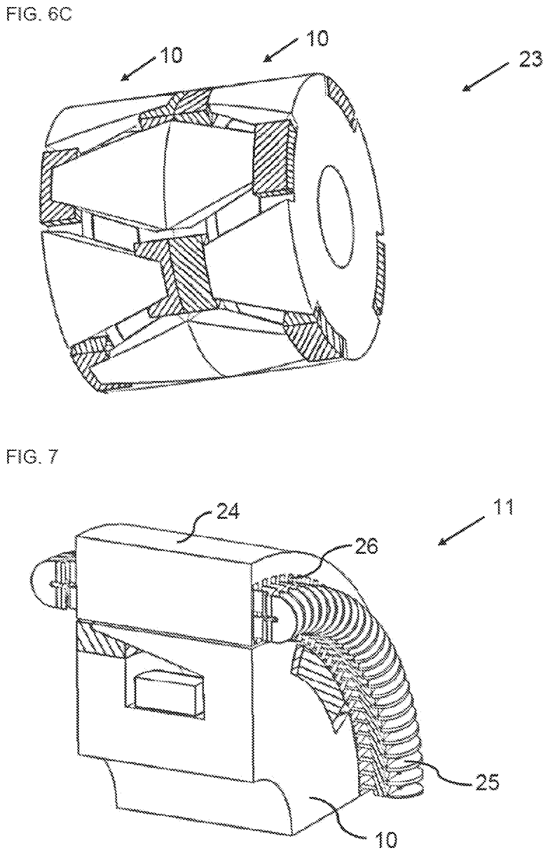

In FIG. 7, a schematic cross-section through a part of an electrical machine having an exemplary embodiment of the claw pole rotor is shown.

In FIG. 1A, a schematic cross-section through a part of an example of an electrical machine 11 is shown. The electrical machine 11 is not an exemplary embodiment. The electrical machine 11 comprises a stator 24 and a claw pole rotor 10. The claw pole rotor 10 is not an exemplary embodiment. The stator 24 has a plurality of slots 26, in which an electrical winding 25 is arranged. Within the stator 24, the claw pole rotor 10 is arranged. The claw pole rotor 10 comprises an exciter coil 21.

In FIG. 1B, a cutout of the claw pole rotor 10 of FIG. 1A is shown. It is shown in this case that the exciter coil 21 is arranged between claw pole fingers 13, 14 and a rotor yoke 12.

In FIG. 2A, an exemplary embodiment of a claw pole rotor 10 for an electrical machine 11 is shown. The claw pole rotor 10 comprises a rotor yoke 12, four first claw pole fingers 13 and four second claw pole fingers 14. The first claw pole fingers 13 and the second claw pole fingers 14 are each connected with the rotor yoke 12. The rotor yoke 12 comprises a first annular component 19 and a second annular component 20. The first claw pole fingers 13 are connected with the first annular component 19. The second claw pole fingers 14 are connected with the second annular component 20. The first claw pole fingers 13 extend from a first side 15 of the claw pole rotor 10 towards a second side 16 of the claw pole rotor 10. The second claw pole fingers 14 extend from the second side 16 towards the first side 15. The first annular component 19 is arranged at the first side 15, and the second annular component 20 is arranged at the second side 16. The first annular component 19 is that part of the rotor yoke 12 arranged at the first side 15 in the form of a ring. The second annular component 20 is that part of the rotor yoke 12 arranged at the second side 16 in the form of a ring. The first annular component 19 can be seen in FIG. 2A between the first claw pole fingers 13. The second annular component 20 is illustrated in one piece with the second claw pole fingers 14. The second claw pole fingers 14, however, may also be separate components. The same applies to the first annular component 19 and the first claw pole fingers 13. The first and second claw pole fingers 13, 14 each have a shorter extension along a longitudinal axis L of the claw pole rotor 10 than the entire claw pole rotor 10.

One first magnet 17 is in each case arranged at the first side 15 between the first claw pole fingers 13. One second magnet 18 is in each case arranged at the second side 16 between the second claw pole fingers 14. Thus, the claw pole rotor 10 as a whole comprises four first magnets 17 and four second magnets 18. The first and the second magnets 17, 18 each are attached to the rotor yoke 12. Thus, the first magnets 17 are attached to the first annular component 19, and the second magnets 18 are attached to the second annular component 20. Each first magnet 17 is in direct contact with one of the second claw pole fingers 14. Each second magnet 18 is in direct contact with one of the first claw pole fingers 13. The sum of the length of one first magnet 17 and the length of one second claw pole finger 14 is equal to the entire length of the claw pole rotor 10. Likewise, the sum of the length of one second magnet 18 and the length of one first claw pole finger 13 is equal to the entire length of the claw pole rotor 10. The first and second magnets 17, 18 each have along a longitudinal axis L of the claw pole rotor 10 a shorter extension than the first and second claw pole fingers 13, 14. Thus, the installation space of the claw pole rotor 10 is efficiently utilized for generating torque.

In FIG. 2B, the exemplary embodiment of the claw pole rotor 10 of FIG. 2A is shown. In this case, the magnetizing directions of the first and second magnets 17, 18 are drawn by way of example by means of arrows. The magnetizing direction of the first magnets 17 and the second magnets 18 respectively runs in parallel to a radial direction r in a cross-section through the claw pole rotor 10. In this case, the magnetizing direction of the first magnets 17 runs in the cross-section through the claw pole rotor 10 towards the center point of the claw pole rotor 10. This means that the magnetizing directions of the four first magnets 17 run in different directions. The magnetizing direction of the second magnets 18 runs in the cross-section through the claw pole rotor 10 away from the center point of the claw pole rotor 10. This means that the magnetizing direction of the second magnets 18 runs in the cross-section through the claw pole rotor 10 from the center point to an outside 27 of the claw pole rotor 10. In this arrangement, each first magnet 17 magnetizes the two adjacent first claw pole fingers 13. Moreover, each second magnet 18 magnetizes the two adjacent second claw pole fingers 14. This results in the fact that the sum of the number of the first magnets 17 and the number of the second magnets 18 is equal to the number of the magnetic poles of the claw pole rotor 10.

In FIG. 3A, a cutout of the exemplary embodiment of the claw pole rotor 10 of FIG. 2A is shown. Both the first claw pole fingers 13 and the second claw pole fingers 14 are attached to the rotor yoke 12, which is located in some places within the claw pole rotor 10. The rotor yoke 12 extends from the first side 15 to the second side 16. It is further shown how the first magnets 17 are attached to the rotor yoke 12. The first magnets 17 are attached to the first annular component 19. The first annular component 19 extends in some places along the longitudinal axis L of the claw pole rotor 10. The first magnets 17 extend just as far as the first annular component 19 along the longitudinal axis L of the claw pole rotor 10. The same applies to the second magnets 18 and the second annular component 20.

In FIG. 3B, a further cutout of the exemplary embodiment of the claw pole rotor 10 of FIG. 2A is shown. In this case, the first annular component 19 with the first claw pole fingers 13 is illustrated. By way of example, one first magnet 17 is shown. The latter is arranged between two first claw pole fingers 13 at the first annular component 19.

In FIG. 3C, a further cutout of the exemplary embodiment of the claw pole rotor 10 of FIG. 2A is shown. In this case, the first annular component 19 with the first claw pole fingers 13 is illustrated as in FIG. 3B. One first magnet 17 is respectively arranged in each case between two first claw pole fingers 13 along the circumference of the first annular component 19.

In FIG. 4A, a further exemplary embodiment of the claw pole rotor 10 is shown. The claw pole rotor 10 is shown in a disassembled state. This is merely used for illustration purposes. The only difference from the exemplary embodiment shown in FIG. 2A is that an exciter coil 21 is arranged between the rotor yoke 12 and the first and second claw pole fingers 13, 14 in the claw pole rotor 10. The exciter coil 21 has approximately the shape of a hollow cylinder. The exciter coil 21 may be wound around a part of the rotor yoke 12, for example a rotor core. In a cross-section through the claw pole rotor 10 in a radial direction r, the exciter coil 21 is arranged between the rotor yoke 12 and the first and second claw pole fingers 13, 14.

In FIG. 4B, a cutout of the exemplary embodiment of the claw pole rotor 10 shown in FIG. 4A is shown. In this case, the claw pole rotor 10 is shown in the assembled state. The exciter coil 21 is arranged spaced from the first and second claw pole fingers 13, 14. Furthermore, the exciter coil 21 is arranged spaced from the first and second annular component 19, 20.

In FIG. 4C, the exemplary embodiment of the claw pole rotor 10 shown in FIG. 4A is shown in the assembled state.

In FIG. 5A, a cutout of a further exemplary embodiment of the claw pole rotor 10 is shown. In this case, the first and second claw pole fingers 13, 14 have along a longitudinal axis L of the claw pole rotor 10 at most the same extension as the entire claw pole rotor 10. The sum of the length of one first or second claw pole finger 13, 14 and the length of one first or second magnet 17, 18 along the longitudinal axis L of the claw pole rotor 10 is larger than the entire length of the claw pole rotor 10. This means that in each case one first claw pole finger 13 runs in some places coaxially to one second magnet 18. In each case, one second claw pole finger 14 runs in some places coaxially to one first magnet 17. In contrast to the exemplary embodiment shown in FIG. 4C, the first and second magnets 17, 18 each have a recess 22 in which a part of one of the claw pole fingers 13, 14 is arranged. The recesses 22 each may be adapted to the shape of the first and second claw pole fingers 13, 14. This means that the first magnets 17 each have a recess 22 for receiving a part of a second claw pole finger 14. The second magnets 18 each have a recess 22 for receiving a part of a first claw pole finger 13. The recesses may be adapted to the claw pole fingers 13, 14 such that the first and second magnets 17, 18 each are flush with the first and second claw pole fingers 13, 14 arranged therein, at an outside of the claw pole rotor 10. The first and second claw pole fingers 13, 14 are arranged in the recesses 22 such that in each case one side of the first and second claw pole fingers 13, 14 is free from the first and second magnets 17, 18. This means that the first and second claw pole fingers 13, 14 by means of one of their sides are not in contact with the first and second magnets 17, 18.

In FIG. 5B, one first magnet 17 of the exemplary embodiment of FIG. 5A is shown. The first magnet 17 has a recess 22. The recess 22 extends partially, i.e. not completely, through the first magnet 17. The second magnets 18 of the exemplary embodiment of FIG. 5A may likewise have the structure shown in FIG. 5B.

In FIG. 5C, a part of the exemplary embodiment shown in FIG. 5A is illustrated. The first annular component 19 having the first claw pole fingers 13 mounted thereto is shown. To the first annular component 19, the first magnets 17 having the recesses 22 are likewise mounted. The second annular component 20 with the second claw pole fingers 14 and the second magnets 18 may likewise have the structure shown in FIG. 5C.

In FIG. 5D, the exemplary embodiment of FIG. 5A is shown. In this case, the entire claw pole rotor 10 is illustrated.

In FIG. 6A, an exemplary embodiment of a rotor arrangement 23 is shown. The rotor arrangement 23 comprises two claw pole rotors 10. The two claw pole rotors 10 each have the structure shown in FIG. 4C. In the connecting plane between the two claw pole rotors 10, the first magnets 17 of one claw pole rotor 10 each adjoin directly the second magnets 18 of the other claw pole rotor 10. Likewise, the first claw pole fingers 13 of one claw pole rotor 10 directly adjoin the second claw pole fingers 14 of the other claw pole rotor 10. The two claw pole rotors 10 are in direct contact with one another.

In FIG. 6B, a further exemplary embodiment of the rotor arrangement 23 is shown. The only difference from the exemplary embodiment shown in FIG. 6A is that the two claw pole rotors 10 each have the structure shown in FIG. 5D.

In FIG. 6C, a further exemplary embodiment of the rotor arrangement 23 is shown. The rotor arrangement 23 comprises two claw pole rotors 10. The two claw pole rotors 10 have a structure that is different from one another. One of the claw pole rotors 10 has the structure shown in FIG. 4A, and the other one of the claw pole rotors 10 has the structure shown in FIG. 5A.

In FIG. 7, a schematic cross-section through a part of an electrical machine 11 having an exemplary embodiment of the claw pole rotor 10 is shown. The claw pole rotor 10 is the exemplary embodiment shown in FIG. 5D. The claw pole rotor 10 is arranged within a stator 24 of the electrical machine 11. The stator 24 has a plurality of slots 26 in which an electrical winding 25 is arranged.

1. A claw pole rotor for an electrical machine, the claw pole rotor comprising
a rotor yoke, and
at least two first claw pole fingers and at least two second claw pole fingers, wherein
the first and second claw pole fingers each are connected with the rotor yoke,
the first claw pole fingers extend from a first side of the claw pole rotor towards a second side of the claw pole rotor,
the second claw pole fingers extend from the second side towards the first side,
one first magnet is in each case arranged at the first side between the first claw pole fingers, and
one second magnet is in each case arranged at the second side between the second claw pole fingers.

2. The claw pole rotor according to claim 1, wherein the first and the second magnets each are attached to the rotor yoke.

3. The claw pole rotor according to claim 1, wherein the magnetizing direction of the first magnets and the second magnets runs in each case in parallel to a radial direction in a cross-section through the claw pole rotor.

4. The claw pole rotor according to claim 1, wherein the magnetizing direction of the first magnets runs in each case in parallel to a radial direction in a cross-section through the claw pole rotor towards a center point of the claw pole rotor, and the magnetizing direction of the second magnets runs in each case in parallel to a radial direction in a cross-section through the claw pole rotor away from the center point of the claw pole rotor.

5. The claw pole rotor according to claim 1, wherein an exciter coil is arranged between the rotor yoke and the first and second claw pole finger within the claw pole rotor.

6. The claw pole rotor according to claim 1, wherein the first and second claw pole fingers each have a shorter extension along a longitudinal axis of the claw pole rotor than the entire claw pole rotor.

7. The claw pole rotor according to claim 1, wherein the first and second claw pole fingers each have at most the same extension along a longitudinal axis of the claw pole rotor as the entire claw pole rotor.

8. The claw pole rotor according to claim 1, wherein the first and second magnets each have a shorter extension along a longitudinal axis of the claw pole rotor than the first and second claw pole fingers.

9. The claw pole rotor according to claim 1, wherein each first magnet is in direct contact with one of the second claw pole fingers, and each second magnet is in direct contact with one of the first claw pole fingers.

10. The claw pole rotor according to claim 1, wherein the first and second magnets each have a recess in which a part of one of the claw pole fingers is arranged.

11. The claw pole rotor according to claim 1, wherein the sum of the number of the first magnets and the number of the second magnets is equal to the number of the magnetic poles of the claw pole rotor.

12. (canceled)

13. The rotor arrangement according to claim 1, wherein at least two of the claw pole rotors of the rotor arrangement have structures which differ from one another.
